(19) United States
(12) Patent Application Publication
(10) Pub. No.: US 2004/0143628 A1
(43) Pub. Date: Jul. 22, 2004

(54) Systems and methods that discover and configure non-TCP/IP networks and devices residing therein

(76) Inventors: Jonathan D. Bradford, Harpersfield Township, OH (US); David M. Callaghan, Concord, OH (US); Brian A. Batke, Novelty, OH (US)

Correspondence Address: Susan M. Donahue, Rockwell Automation, 704-P, IP Department, 1201 South 2nd Street, Milwaukee, WI, 53204, US

(21) Appl. No.: 10/753,252

(22) Filed: Jan. 8, 2004

Related U.S. Application Data
(62) Division of application No. 09/990,334, filed on Nov. 23, 2001.
(63) Continuation-in-part of application No. 09/967,742, filed on Sep. 28, 2001.
(60) Provisional application No. 60/520,042, filed on Nov. 14, 2003.
(60) Provisional application No. 60/285,292, filed on Apr. 20, 2001.

(51) Int. Cl. G06F 15/16

(52) U.S. Cl. 709/203

(57) ABSTRACT

The present invention relates to systems and methods that provide Web-based interaction with components (e.g., controllers, devices, systems, computers, etc.) residing on TCP/IP (e.g., Ethernet/IP) and/or non-TCP/IP (e.g., DeviceNet and ControlNet) based networks. The systems and methods utilize a novel approach wherein an interface component and an engine, along with software that enables Web functionality for non-TCP/IP-based networks, are employed in connection with a computing system or a module. A user can access the interface component via any known means utilized to communicate with TCP/IP-based networks such as an Internet connection and Web browser. From the interface component, the engine can be invoked to discover disparate networks and/or associated devices, and/or provide access to such entities. In addition, the discovered devices can be dynamically updated to reflect a present state. The user and/or a device can employ the interface component to communicate with, monitor, control and configure any discovered device.

### RELATED APPLICATIONS

This application claims the benefit of U.S. Provisional Patent Application Serial No. 60/520,042 filed on Nov. 14, 2003 and entitled “SYSTEMS AND METHODS THAT DISCOVER AND CONFIGURE NON-TCP/IP NETWORKS AND DEVICES RESIDING THEREIN,” the entirety of which is incorporated herein by reference.

This application is a Continuation-in-Part of pending U.S. patent application Ser. No. 09/967,742 filed on Sep. 28, 2001 and entitled “PROXIED WEB ACCESS FOR CONTROL DEVICES ON INDUSTRIAL CONTROL SYSTEMS,” which claims the benefit of U.S. Provisional Patent Application Serial No. 60/285,292 filed on Apr. 20, 2001.

### TECHNICAL FIELD

The present invention generally relates to industrial control systems, and more particularly to systems and methods that provide Web-based access to a device residing on a non-TCP/IP network within an industrial environment.

### BACKGROUND OF THE INVENTION

A typical computer network comprises a plurality of interconnected microprocessor-based devices with specialized (e.g., network) software and/or hardware that facilitates interaction between at least two devices on the network. Such interaction can provide for a fast, efficient and cost-effective means to monitor, control and/or exchange information amongst networked devices. In many instances, peripheral devices such as printers, plotters and terminals can be coupled to the network or locally to devices on the network to enhance the usability of information. For example, data can be visually presented on paper as a graph(s), a table(s), a chart(s), and the like through a printer, etc.

Such networks are generally categorized and differentiated through characteristics such as size and user base, architecture, and topology. For example, a network can be referred to as a Local Area Network (LAN) or a Wide Area Network (WAN), dependent on the network size. For example, a LAN is typically associated with a relatively small geographic area such a department, a building or a group of buildings, and employed to connect local workstations, personal computers, printers, copiers, scanners, etc. and a WAN typically is associated with networks that span larger geographical areas, and can include one or more smaller networks, such as one or more LANs. For example, a WAN can be employed to couple computers and/or LANs that reside on opposite ends of a country and/or world. The most popular WAN today is the Internet.

Architectural differentiation includes classifications such as a peer-to-peer and client/server networks. With a peer-to-peer architecture, computers are connected to one another (e.g., via a hub) and share the same level of access on the network. In addition, the computers can be configured with security levels and/or sharing rights such that files can be directly accessed and shared peer to peer, or between computers. In contrast, a client/server network comprises at least one client machine, which can be a user's computer, and a server, which typically is employed to store and execute shared applications in connection with one or more clients.

Common topologies include bus, ring and star. With a bus topology, a central channel or backbone (the bus) couples computers and/or devices on the network. With a ring topology, computers and/or devices are coupled to one another as a closed loop. Thus, information may travel through the several computers in order to convey information from one computer to another. With a star topology, computers and/or are connected to a central computer.

The benefits provided by such networks can be exploited in industrial settings to improve control and monitoring of industrial devices. A typical industrial device (including a programmable logic controller, or PLC) comprise a plurality of modules such as a control module(s), an interface module(s) and an I/O module(s) utilized in connection with electrical, mechanical, hydraulic and pneumatic systems and processes. Control commonly is achieved via virtual relays, contactors, counters, timers and other means through hardware, software and/or firmware that can be user (e.g., user written, application specific code) configured. I/O provides a mechanism for communication between systems and the environment. For example, an input channel can be employed to receive analog and digital signals through sensors, switches and the like that provide information indicative of state(s) (e.g., on/off) and/or relating to a process(s). An output channel can be employed to convey a next state to an instrument under the control of the controller. Such industrial devices have enabled modern factories to become semi and/or fully automated.

As the World Wide Web becomes more ubiquitous, Web-based interfaces are becoming a preferred means to interact with systems and devices over a network. For example, Web-based interfaces have been developed to monitor and control entities such as lighting, security, audio/video entertainment centers, door locks, etc., as well as monitor internal and external locations. However, Web-based interfaces generally are only provided for TCP/IP-based systems and not non-TCP/IP-based systems; and non-TCP/IP-based systems are commonly employed within industrial environments.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates to systems and methods that provide Web-based access to components (e.g., devices, systems, computers, etc.) residing on non-TCP/IP and TCP/IP-based networks. Conventionally, Web-based interfaces are provided for communication within TCP/IP-based networks, but not non-TCP/IP networks. Thus, the systems and methods of the present invention provide a novel approach that can enhance and improve conventional techniques. Such enhancement and improvement can be achieved via a novel interface that enables Web functionality with non-TCP/IP-based networks (e.g., via software) and that facilitates Web-based communication with components residing on the non-TCP/IP-based networks. Hence, the novel intelligent interface of the present invention can be utilized in connection with various disparate networks, wherein a Web-based application can be employed to communicate with, monitor, control and configure components residing on respective disparate networks. The foregoing benefits provided by the present invention can be exploited in industrial environments where many networked components reside within non-TCP/IP-based networks such CIP (e.g., DeviceNet and ControlNet), Data Highway Plus, etc., for example.

In one aspect of the present invention, a portal is provided that that can provide secure interaction between TCP/IP and non-TCP/IP networks. The portal comprises a TCP/IP interface with software that enables TCP/IP Web functionality with non-TCP/IP-based networks. The portal can be associated with a browse engine that can discover available TCP/IP and non-TCP/IP-based networks and networked components, and facilitate conveyance of information between such components. The novel system provides for Web-based interaction with non-TCP/IP-based networks and/or components. Examples of such interaction include, but are not limited to, requests to monitor, control and configure a particular network(s) and/or associated component(s), return available networks and/or associated components, and obtain information from manuals, Web pages, logs, code, etc. Such novel Web-based capabilities can be utilized within the industrial environment (e.g., plants, manufacturing facilities, etc.) to monitor, control, configure and communicate with industrial components (e.g., controllers, modules, etc.) residing on non-TCP/IP-based networks.

In another aspect of the present invention, a system is depicted that provides an entryway to non-TCP/IP networks and/or components residing therein. A gateway can be utilized to interface the non-TCP/IP and TCP/IP-based networks, wherein a TCP/IP-based Web browser can be employed to facilitate communication, including monitoring, controlling and configuring and/or obtaining information regarding components residing on non-TCP/IP networks. A user can initiate communication via providing information indicative of the desired action. The information can be delivered to a network/device arbitrator that can discover and communicate with non-TCP/IP-based networks and associated components. In response to various requests, the arbitrator can present available TCP/IP and non-TCP/IP-based networks and/or associated components to the user for selection and provide access to a user-selected network and/or associated component. The arbitrator can utilize data stored within a network, a component and/or an information bank to facilitate servicing requests.

In yet another aspect of the present invention, a system is provided that facilitates secure communication with devices residing on non-TCP/IP-based networks. A user can employ a Web-based application and interact with a network interface and network mapper in order to monitor, control, configure and obtain information related to a non-TCP/IP network and associated device. The system can employ a single and/or multi-tier security approach that mitigates security breeches and provides for greater security flexibility and customization. In one instance, the network interface can include a security mechanism that mitigates unauthorized access to a network and/or device. In another instance, respective networks can provide a security mechanism that mitigates unauthorized access to devices residing therein. In yet another instance, respective devices can be configured to mitigate unauthorized access.

In still another aspect of the present invention, systems are provided that utilize a Web Proxy Page and Network Browse Engine to facilitate Web-based communication with devices residing on non-TCP/IP-based networks. In one instance, the Web Proxy Page and Network Browse Engine reside within a microprocessor-based platform. A user can employ a Web-based application to interface with the platform via a Web-based network. The user can then employ the Web Proxy Page and Network Browse Engine to locate and facilitate access with various disparate networks and any device associated therewith. In another instance, the Web Proxy Page and Network Browse Engine reside within a TCP/IP-based module. A user can employ a Web-based application to interface with the module. The user can then employ the Web Proxy Page, Network Browse Engine and a routing component to locate and facilitate access with devices residing on disparate networks.

In other aspects of the present invention, a system is provided that employs intelligence to facilitate Web-based interaction with non-TCP/IP-based networks and associated devices. Such intelligence can include employing statistics, probabilities, inferences and/or classifiers and can facilitate discovering and locating networks and/or devices and providing access to a selected network or device. Moreover, various methods are provided that can discover and present available disparate network and/or device associated therewith to a user, wherein a user can select a network and/or device to access from the presented networks and devices, that can service a user-request for a disparate network and/or associated device, and that can discover added and/or removed networks and/or devices and subsequently update available networks and devices. In addition, the methods can employ intelligence (e.g., statistics, probabilities, inferences and/or classifiers) to facilitate such capabilities.

The following description and annexed drawings set forth in detail certain illustrative aspects of the present invention. These aspects are indicative, however, of but a few of the various ways in which the principles of the invention may be employed and the present invention is intended to include all such aspects and their equivalents. Other advantages and novel features of the present invention will become apparent from the following detailed description of the invention when considered in conjunction with the drawings.

### BRIEF DESCRIPTION OF THE DRAWINGS

FIG. 1 illustrates an exemplary system that provides an entryway to components residing on disparate networks, in accordance with an aspect of the present invention.

FIG. 2 illustrates an exemplary system that provides a gateway to non-TCP/IP networks and/or components residing therein, in accordance with an aspect of the present invention.

FIG. 3 illustrates an exemplary system that provides secure communication to components on disparate networks, in accordance with an aspect of the present invention.

FIG. 4 illustrates an exemplary system that provides Web-based access to TCP/IP and/or non-TCP/IP networks and/or devices via a TCP/IP-based platform, in accordance with an aspect of the present invention.

FIG. 5 illustrates an exemplary system that provides Web-based access to TCP/IP and/or non-TCP/IP networks and/or devices via a TCP/IP-based module, in accordance with an aspect of the present invention.

FIG. 6 illustrates an exemplary system that utilizes intelligence to facilitate Web-based access to components on disparate networks, in accordance with an aspect of the present invention.

FIG. 7 illustrates an exemplary methodology that provides access to disparate networks and/or devices therewith, in accordance with an aspect of the present invention.

FIG. 8 illustrates an exemplary methodology that provides access to a user-selected device residing on a non-TCP/IP network, in accordance with an aspect of the present invention.

FIG. 9 illustrates an exemplary methodology that services requests for disparate networks and/or associated devices, in accordance with an aspect of the present invention.

FIG. 10 illustrates an exemplary methodology that discovers disparate networks and/or associated devices, in accordance with an aspect of the present invention.

FIG. 11 illustrates an exemplary environment wherein the novel aspects of the invention can be employed.

FIG. 12 illustrates a second exemplary environment wherein the novel aspects of the invention can be employed.

### DETAILED DESCRIPTION OF THE INVENTION

The present invention relates to systems and methods that couple non-TCP/IP and TCP/IP-based networks such that Web-based applications can be utilized to communicate with, monitor, control and configure components residing on both the non-TCP/IP and TCP/IP-based networks. In general, the systems and methods herein provide a novel interface that includes Web functionality enabling software for non-TCP/IP-based networks, wherein the interface facilitates Web-based interaction with components residing on the non-TCP/IP-based networks. Thus, the novel systems and methods of the present invention can be utilized within industrial settings, wherein many components (e.g., controllers, devices, systems, computers, etc.) reside on non-TCP/IP networks such as DeviceNet and ControlNet and other CIP networks and DH+ networks. The foregoing can provide an improvement over conventional system wherein Web-based communication is provided for TCP/IP-based networks, and not non-TCP/IP-based networks.

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used herein, the terms “component,” “device,” “controller,” and the like are intended to refer to a computer-related entity, either hardware, a combination of hardware and software, software, or software in execution. For example, a component can be, but is not limited to, a process running on a processor, a processor, an object, an executable, a thread of execution, a program, a microprocessor, a processing unit and/or a computer. In addition, one or more components can reside within a process and/or thread of execution and a component can be localized on a computer and/or distributed amongst a plurality of computers. Furthermore, such components can be executed within various computer readable media, wherein respective media can be associated with disparate data structures. Moreover, such components can communicate via local and/or remote processes, for example, in accordance with a signal with one or more data packets (e.g., data from a component interacting with another component in a local system, distributed system, and/or across a network such as the Internet with other systems via the signal).

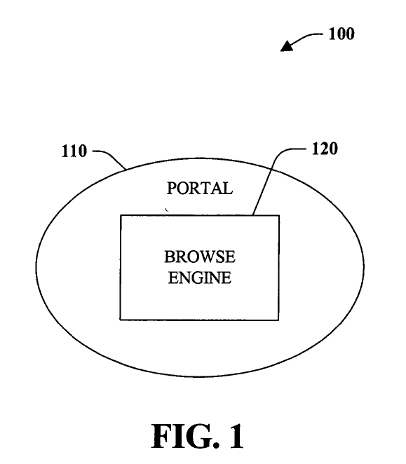

FIG. 1 illustrates a system 100 that provides an entryway to components residing on disparate networks, in accordance with an aspect of the present invention. The system 100 comprises a portal 110 that can interface TCP/IP and non-TCP/IP networks and a browse engine 120 that can facilitate communication between components residing on the interfaced networks.

The portal 110 typically comprises a TCP/IP interface that can be coupled to virtually any TCP/IP network (e.g., EtherNet/IP). In addition, the portal 110 can include software that enables TCP/IP Web functionality for non-TCP/IP-based networks (e.g., CIP, Data Highway Plus, etc.). Thus, the portal can provide a mechanism for a component residing on a TCP/IP-based network to communicate with a component residing on a non-TCP/IP-based or another TCP/IP-based network.

In general, the portal 110 can invoke the browse engine 120 to facilitate communication, wherein the browse engine 120 can search for and discover available TCP/IP and non-TCP/IP-based networks and networked components, and facilitate conveyance of signals (e.g., with messages, configuration, parameters, control, settings, data, information, etc.) between components. In one aspect of the invention, the browse engine 120 can be invoked in response to a request to access (e.g., monitor, control, configure, obtain information about, etc.) a particular network (e.g., TCP/IP and non-TCP/IP) and/or associated component and/or return available networks (e.g., TCP/IP and non-TCP/IP) and/or associated components. In another aspect of the present invention, the browse engine 120 can be invoked to update information that can be utilized to indicate available TCP/IP and non-TCP/IP networks and/or associated components. For example, a TCP/IP or non-TCP/IP network and/or component can be added or removed to the system; and thus, the browse engine 120 can facilitate refreshing information provided to a user to present current information that reflects the addition or removal.

The foregoing provides the ability to monitor, control, configure and communicate with components on a non-TCP/IP and/or TCP/IP-based network through a Web-based interface. For example, in one aspect of the present invention a user can launch a Web-based network browser from a component residing on a TCP/IP-based network and transmit a request through the portal 110 to identify one or more (including all) disparate (e.g., TCP/IP and non-TCP/IP) networks and/or associated components, to determine whether a particular disparate network and/or component is available, and to access one or more of the disparate networks and/or associated components.

The browse engine 120 can be utilized to facilitate servicing such request via interrogating and scrutinizing the system, returning available networks and/or components, and/or providing access to a network and/or component. In another aspect of the present invention, the user can launch the Web-based network browser, establish communication with the portal 110, view available networks and/or components (e.g., as discovered via the browse engine 120), and select one or more networks and/or components to monitor, control and/or configure and/or obtain related information such as manuals, web pages, logs, code, etc. Alternatively or in addition, the browse engine 120 can return a representation of a disparate network(s) and/or component(s). A user can employ the representation (e.g., within a browser) to monitor, control and/or configure the disparate network(s) and/or components (s). Furthermore, the representation can be updated, or refreshed (e.g., in real-time) with data (e.g., state, physical characteristics, etc.) from the network(s) and/or components (s).

Conventionally, Web-based interfaces are created for TCP/IP communication (e.g., between components residing within TCP/IP-based networks) and do not support non-TCP/IP-based networks. Thus, the present invention improves upon conventional systems and allows Web-based monitoring, control, configuration and communication with non-TCP/IP networks and components therewith. Thus, system 100 can be employed and exploited in connection with industrial systems to provide for Web-based interaction with components residing on non-TCP/IP-based networks such as DeviceNet, ControlNet, etc.

It is to be appreciated that the portal 110 can be configured to provide a secure entry point, wherein unauthorized users can be prevented from accessing one or more non-TCP/IP-based networks and/or associated components. Such security mechanism can comprise any known technique, including password protection, encryption, a firewall, and the like.

In another aspect of the present invention, the portal 110 can provide a USB (Universal Serial Bus) interface. Thus, a component can convey information to the portal 110 via USB and/or TCP/IP, wherein the information can be tunneled through the portal 110 via USB. Such information can be conveyed to a component residing on a disparate network via a USB to Ethernet/IP, DeviceNet, ControlNet, USB, etc. interface that is associated with the network and/or the component.

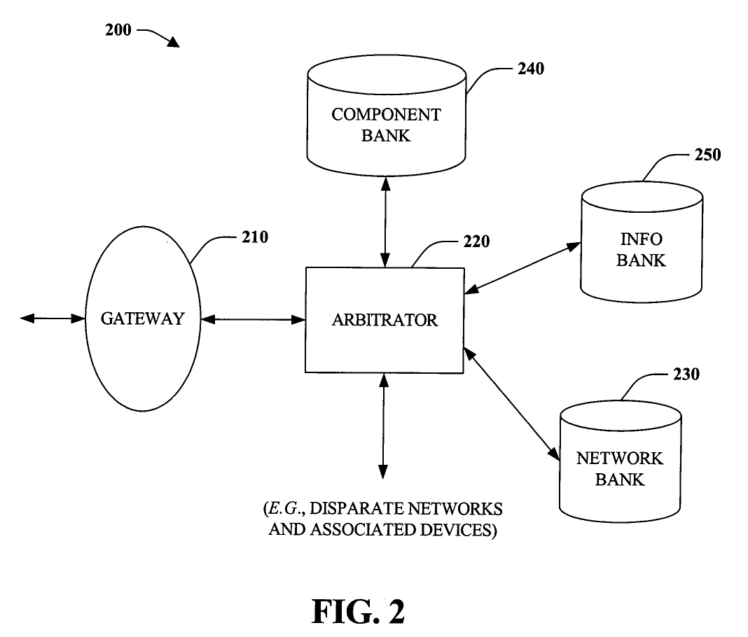

FIG. 2 illustrates a system 200 that provides a gateway to non-TCP/IP networks and/or components residing therein, in accordance with an aspect of the present invention. The system 200 comprises a gateway 210 that couples disparate networks, an arbitrator 220 that facilitates accessing such networks and/or components as well as related information, a network bank 230 that stores network related data, a component bank 240 that stores device related data, and an information bank 250 that stores general data.

The gateway 210 can be utilized to interface one or more non-TCP/IP networks (e.g., similar and/or different) with one or more TCP/IP networks and provide an entry point for a user to access a component on a non-TCP/IP network via a standard TCP/IP-Web-based browser. Conventionally, Web-based interfaces are provided for TCP/IP communication and do not support interaction with non-TCP/IP networks. Thus, the present invention provides a novel technique that extends and improves upon conventional systems. Such novel aspects can be exploited in the industrial environment wherein both TCP/IP and non-TCP/IP-based networks are commonly utilized. For example, any TCP/IP-based client can be utilized to monitor, control and configure and/or obtain information regarding components residing on industrial TCP/IP and non-TCP/IP networks via a Web browser.

A user employing a Web client can establish a connection with the gateway 210 and initiate a search for available and/or a particular non-TCP/IP-based network and/or component. For example, the user can launch a Web browser, access a Web application associated with the gateway, and provides information (e.g., via the Web application) that is indicative of the desired action. The information can include: a particular node that the user desires to locate; a type of node; characteristic such as recently added nodes, faulted nodes, nodes the user is responsible for maintaining, etc.; keywords (e.g., within manuals, log files, html files, etc.); and links to known search engines. In addition, the searching capabilities can be user configured. For example, the user can specify how and when the results of the search should be presented. For example, returned results can be ranked and/or filtered. Such information can be utilized by the arbitrator 220 to facilitate locating and providing access to non-TCP/IP-based network(s), associated component(s) and/or related information.

In another aspect of the present invention, the gateway 210 can present available TCP/IP and non-TCP/IP-based networks and/or associated components to the user for selection. For example, the arbitrator 220 can search the system and discover and identify available TCP/IP and non-TCP/IP-based networks and/or associated components and provide such information to any Web client interacting with the gateway 210. In addition, when a network and/or component is added to the system, the arbitrator 220 can discover the newly added entity via periodically polling (e.g., automatic and manual) for newly added entities and/or receiving a message indicating such addition. The arbitrator 220 can refresh the presented information (e.g., via a list, a tree, a grid, etc.) with the newly acquired information. It is to be appreciated that removal of a network and/or component can likewise invoke and update of the presented information.

As noted above, the arbitrator 220 can receive a request for a non-TCP/IP based network and/or component through the gateway 210. Such request can include information indicative of the network and/or component, as well as other information (e.g., request originator, location, time, date, sort, filter, unique identifiers, etc.) that can further facilitate locating networks and/or components. The arbitrator 220 can extract and employ such information. For example, in one aspect of the present invention the information can be utilized in connection with a search through the network bank 230 and/or the component bank 240 to determine whether the requested network and/or component have already been identified. If it is determined that the requested network and/or component have been identified, then the arbitrator 220 can retrieve associated information (e.g., manuals, log files, web pages, and the like) from the information bank 250 and return such information to the user and/or provide the user with access to the network and/or component (e.g., to registers, memory, error codes, debuggers, microprocessors, etc.).

In another aspect of the present invention, the information associated with the request can be utilized to scrutinize the system for networks and/or components in order to determine whether a network and/or component is coupled, configured and/or active. Once locating a network and/or component, the arbitrator 220 can obtain network, component and/or other information, for example, from memory (e.g., local and remote) associated with the network and/or component. Such information can be stored in the network bank 230, the component bank 240 and the information bank 250, respectively, and retrieved in connection with subsequent requests.

It is to be appreciated that components residing on non-TCP/IP-based networks can communicate with other components residing on the same and different non-TCP/IP-based networks via the arbitrator 220. Similar to the description above, a user of a component on a non-TCP/IP-based can transmit a request wherein the arbitrator 220 can utilize the information within the request and any data saved within the network bank 230, component bank 240, and information bank 250 to service the request.

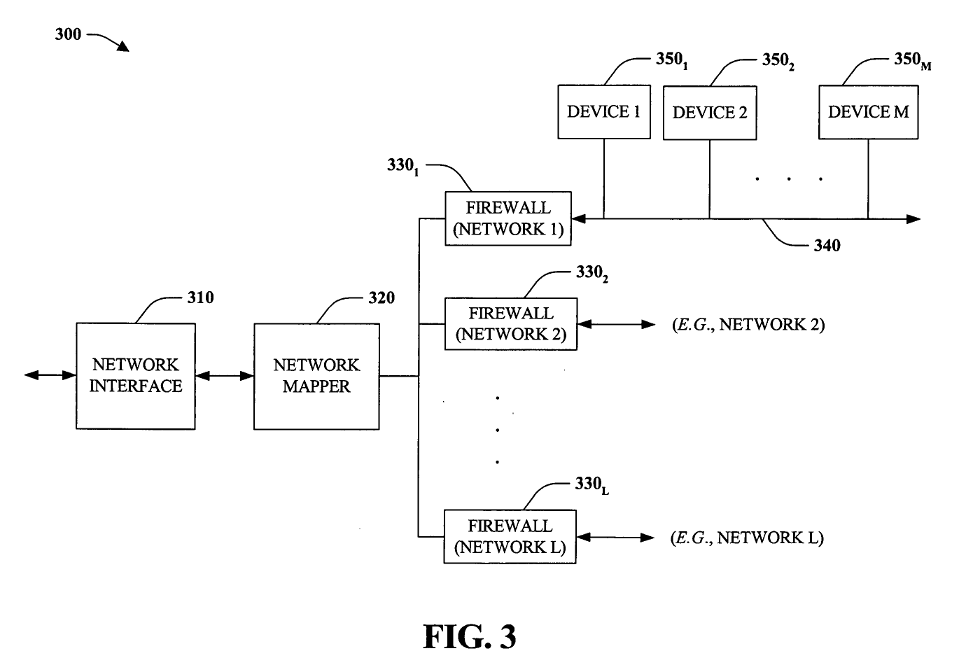

FIG. 3 illustrates a system 300 that provides secure communication to devices residing on disparate networks, in accordance with an aspect of the present invention. The system 300 comprises a network interface 310 that can couple TCP/IP and non-TCP/IP-based networks. As such, TCP/IP based utilities such as Web-based applications can be utilized to interact with non-TCP/IP networks and/or devices through the network interface 310.

The network interface 310 can employ a network mapper 320 to facilitate locating and communicating with non-TCP/IP networks. For example, the network mapper 320 can provide suitable communication protocols, software, and/or interfaces to various disparate non-TCP/IP networks. In addition, the network mapper 320 can determine which network a particular device is associated with such that a user who desires to monitor, control, configure and/or communicate with a particular device can access such device without knowing the associated non-TCP/IP network.

In one aspect of the present invention, one or more non-TCP/IP networks can be associated with respective firewalls 330₁, 330₂ and 330_{L} (hereafter referred collectively as firewalls 330), wherein L is an integer equal to or greater than one. Such firewalls 330 can be utilized to provide selective access to disparate networks. For example, an account can be generated for a particular user, wherein the user can be provided with authorization to access one or more of the disparate networks. In one aspect of the invention, when a user attempts to access a network, the user is prompted for authorization. If the user successfully provides valid authorization, the network can be made available to the user. If the user is deemed unauthorized, the user can be denied access, re-directed and/or notified that permission could not be granted based on the user's current profile.

A user with authorization to a non-TCP/IP network can be provided with selective access to the one or more devices residing on the network. For example, a user with valid authorization for access to network 340 can be provided with access to one or more of devices 350₁, 350₂ and 350_{M}, wherein M is an integer equal to or greater than one. Similar to network access, a respective device can be configured to require authorization. Thus, one or more devices can be made available to any user with access to the non-TCP/IP network. Thus, the present invention provides for multi-tier security to mitigate single point security breeches and to provide for greater security flexibility and customization. In addition or alternatively, the network interface 310 can include a firewall that can be configured to mitigate network and/or device access by unauthorized users.

It is to be appreciated that access to a network and/or device can include the ability to monitor, control, configure and obtain related information. For example, the user can employ a Web-based application to can communicate through the network interface 310 and display current settings and performance, wherein the user can change settings and observe the affects. In one aspect of the invention, a simulation component (not shown) can be invoked to predict the response to various setting changes prior to implementing such changes. In anther example, manuals, logs, history, code, etc. that are related to the network and/or device can be viewed and/or downloaded. In addition, the foregoing information as well as other information can be uploaded to the network and/or device.

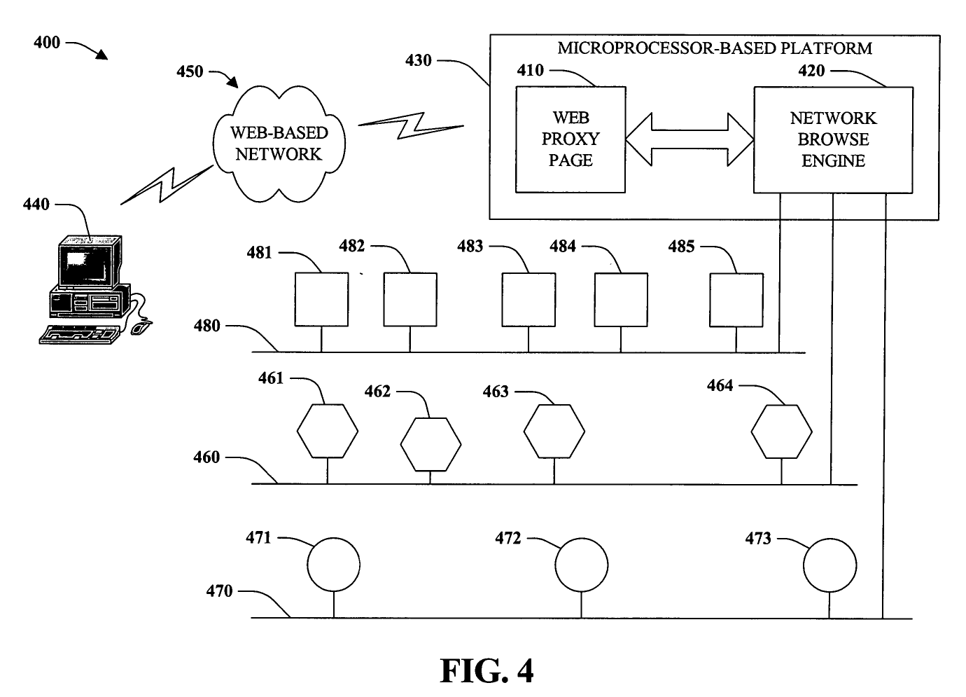

FIG. 4 illustrates a system 400 that provides Web-based access to TCP/IP and/or non-TCP/IP networks and/or devices, in accordance with an aspect of the present invention. The system 400 comprises a Web Proxy Page 410 and a Network Browse Engine 420. The Web Proxy Page 410 can provide a portal between one or more TCP/IP-based networks and one or more non-TCP/IP-based networks, wherein Web functionality can be utilized to communicate with the non-TCP/IP-based networks. The Web Proxy Page 410 can be utilized in connection with the Network Browse Engine 420, which can facilitate communication with the one or more non-TCP/IP-based networks, including message conveyance, monitoring, controlling, configuring and/or obtaining information with devices residing thereon.

A user interacting with the Web Proxy Page 410 can invoke the Network Browse Engine 420 to determine available non-TCP/IP networks and/or associated devices, browse one or more non-TCP/IP networks, access one or more associated devices, obtain related information, and configure network(s) and/or a device(s) via a Web application. In addition, the Web Proxy Page 410 can provide a single point of access to the one or more non-TCP/IP networks; and thus, can be utilized to provide security (e.g., via a security policy) wherein authorized users can access networks, networked devices and associated information.

As depicted, the Web Proxy Page 410 and the Network Browse Engine 420 can reside within a conventional microprocessor-based platform 430 such as a computer. However, it is to be appreciated the Web Proxy Page 410 and/or the Network Browse Engine 420 could reside outside of the microprocessor-based platform 430. For example, the Web Proxy Page 410 and the Network Browse Engine 420 could reside within different platforms.

By way of example, a user employing a computing component 440 can interface (e.g., CAT5 UTP 8-wire cable and wireless (e.g., radio frequency, or RF)) with the Web-based network 450 (e.g., an internet, an intranet and the Internet), invoke a Web-based browser and access the Web Proxy Page 410. Through the Web Proxy Page 410 and the Network Browse Engine 420, the user can access one of the devices 461, 462, 463, 464, 471, 472 and 473 on one of the non-TCP/IP networks 460 and 470 and/or one of the devices 481, 482, 483, 484, and 485 on a TCP/IP network 480. In addition, a user employing any of the foregoing devices can access another device through the Web Proxy Page 410 and the Network Browse Engine 420. When accessing any of the devices, a cookie can be transmitted saved within the computing component 440. As known, cookies can be utilized to track the path of a user, including which non-TCP/IP-based networks and/or devices are accessed.

In one aspect of the present invention, the Web Proxy Page 410 can be coupled with the Network Browse Engine 420 via CGI or Java linked to C code and the Network Browse Engine 420 can employ RSLinx, for example. In addition, the Network Browse Engine 420 can be configured to communicate with the plurality of disparate networks 460, 470 and 480 and/or associated devices 461-464, 471-473, and 481-485. Examples of suitable TCP/IP-based networks include EtherNet/IP, EtherNet 10Base-T, 100Base-T (Fast EtherNet) and 1000Base-T (Gigabit EtherNet), and examples of suitable non-TCP/IP-based networks include ControlNet, and DeviceNet based networks.

When accessing a non-TCP/IP-based network, a network node can include Web pages and/or Web applications that can provide for viewing data and/or configuring devices. Such Web pages can be stored in an instance(s) of a file or Web object (e.g., for CIP modules) and/or within local or remote memory, for example, and Web applications can be supported via Java and/or markup-language (e.g., XML, HTML, XHTML, etc.), for example. A network node can additionally or alternatively be associated with non-Web page based information. In such instances, standard information such as name and revision, for example, can be displayed. Further, links can be provided to external site hosting pages.

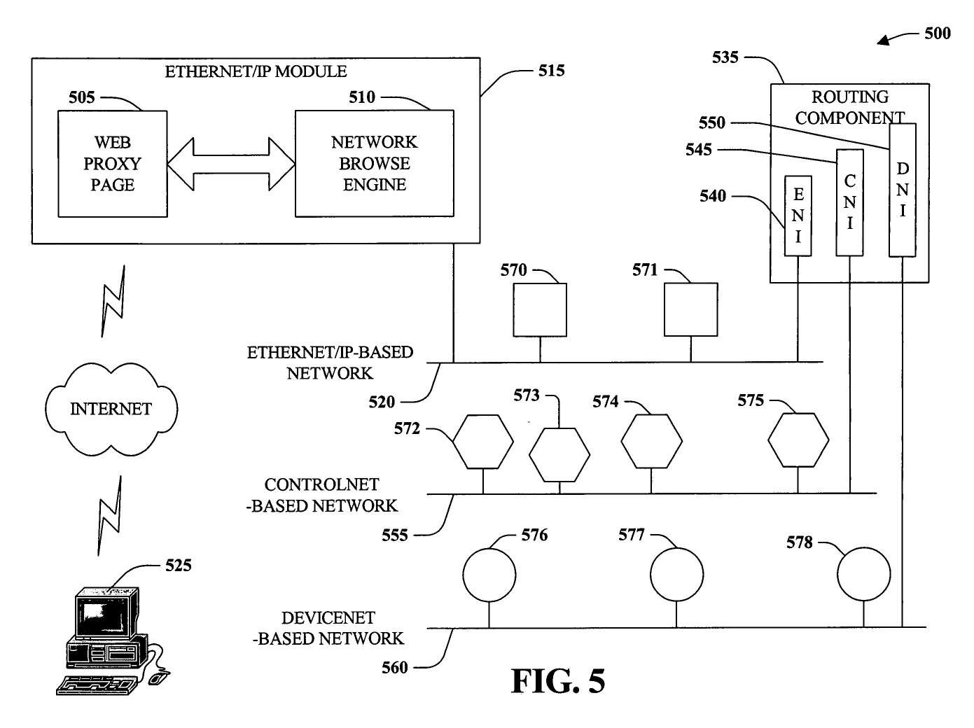

FIG. 5 illustrates a system 500 that provides Web-based access to TCP/IP and/or non-TCP/IP networks and/or components, in accordance with an aspect of the present invention. The system 500 comprises a Web Proxy Page 505 and a Network Browse Engine 510. The Web Proxy Page 505 can provide a gateway between TCP/IP-based applications and devices residing on non-TCP/IP-based networks via an interface with software that enable Web functionality for non-TCP/IP-based networks. The Web Proxy Page 505 employs the Network Browse Engine 510 to facilitate Web-based communication with the devices within the non-TCP/IP-based networks.

As depicted, both the Web Proxy Page 505 and Network Browse Engine 510 reside within an Ethernet/IP module 515 coupled to an EtherNet/IP-based network 520. However, it is to be appreciated the Web Proxy Page 505 and/or the Network Browse Engine 510 could reside outside of the Ethernet/IP module 515. For example, the Web Proxy Page 505 and the Network Browse Engine 510 could reside within different modules on the network 520.

In general, a user employing the computing component 525 can initiate an on-line connection with the Internet. As noted above, any known network interface can be employed to establish an Internet connection, such as hardwire or wireless, for example. Once an on-line session is established, the user (e.g., with valid authorization) can access the Ethernet/IP module 515 (e.g., via an IP address) and invoke the Web Proxy Page 505. From the Web Proxy Page 505, the user can deploy the Network Browse Engine 510 to search for a particular network(s) and/or networked device(s) and/or discover and present available networks and/or networked devices. For example, the user can request a list of the non-TCP/IP networks that are available, browse such networks and related information (e.g., Web pages, manuals, etc.), and configure and control devices residing on the networks.

The browse engine 510 can communicate with various disparate networks via a routing component 535. For example, the routing component 535 can includes an EtherNet/IP interface 540, a ControlNet interface 545 and a DeviceNet interface 550, for example. The EtherNet/IP interface 540 can be employed to interface with the EtherNet/IP network 520, the ControlNet interface 545 can be employed to interface with the ControlNet network 555, and the DeviceNet interface 550 can be employed to interface with the DeviceNet network 560. It is noted that only three interfaces (EtherNet/IP interface 540, ControlNet interface 545 and DeviceNet interface 550) are illustrated for sake of brevity and that various other and additional interfaces can be employed in accordance with an aspect of the present invention to communicate with respective networks.

The Ethernet/IP module 515 can be coupled to the EtherNet/IP interface 540 via a node on the EtherNet/IP network 520. A user employing the computing component 525 can browse a network (e.g., the EtherNet/IP network 520, ControlNet network 555, and DeviceNet network 560) and/or access any of the devices 570-578 via employing the Web Proxy Page 505 and the Network Browse Engine 510. When accessing anon-TCP/IP-based network, a network node can include Web pages and/or Web applications that can provide for viewing data and/or configuring devices. Such Web pages can be stored in an instance(s) of a file or Web object (e.g., for CIP modules) and/or within local or remote memory, for example, and Web applications can be supported via Java and/or markup-language (e.g., XML, HTML, XHTML, etc.), for example. A network node can additionally or alternatively be associated with non-Web page based information. In such instances, standard information such as name and revision, for example, can be displayed. Further, links can be provided to external site hosting pages. Similar to accessing devices associated with TCP/IP-based networks, a device residing on the non-TCP/IP network can transmit a cookie that can be saved to the system 525.

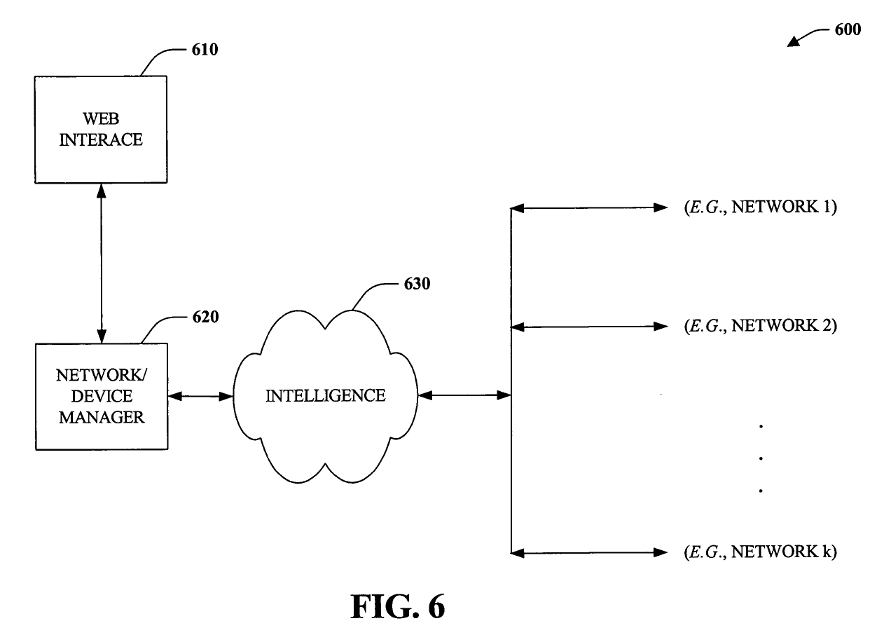

FIG. 6 illustrates a system 600 that utilizes intelligence to facilitate Web-based access to disparate networks and/or components, in accordance with an aspect of the present invention. The system 600 comprises a Web interface 610, which can be an application(s) or a portion of an application executing in connection with one or more devices, such as a laptop, notepad, personal computer (e.g., desktop, mini-tower and tower), palm pilot, handheld, personal data assistant, mainframe, cell phone, terminal (e.g., “dumb” terminal), tablet PC, HMI, and the like. For example, the Web interface 610 can be code executing within one or more of the foregoing microprocessor-based components, wherein the code can reside in local memory such as any suitable type of RAM or ROM, virtual memory, hard disk, etc. and/or an external storage such as CD, DVD, optical disk, floppy disk, tape, memory stick, portable hard drive, etc.

In addition, off-the-shelf and/or specialized (e.g., proprietary) hardware such as accelerators, dedicated processing chips and high-speed communication channels can be employed in connection with the Web interface 610 to increase performance, enhance user capabilities, increase transmission and rendering rates and improve aesthetics. Furthermore, firmware can be utilized to provide low-level executable instructions, parameters and/or control code, and provide a flexible means to upgrade and/or revision hardware functionality and performance.

In one instance, the Web interface 610 can be a web browser. As such, the Web interface 610 can comprise mechanisms (e.g., input and output) that facilitate communication and/or interaction over a network. For example, the Web interface 610 can comprise text and/or graphic presenting (e.g., output) regions comprising dialogue boxes, static controls, drop-down-menus, list boxes, pop-up menus, and graphic boxes. The presenting regions can further include utilities to facilitate display. For example, the presenting regions can include vertical and/or horizontal scroll bars to facilitate navigation and toolbar buttons to determine whether a region will be viewable, to adjust zoom, orientation and color/gray scale. A user can interact with the presenting regions to view, select and provide information via various devices such as a mouse, a roller ball, a keypad, a keyboard, a pen and/or voice activation, for example.

Input regions utilized to transmit information can employ similar mechanism (e.g., dialogue boxes, etc.), and, in addition, utilities such as edit controls, combo boxes, radio buttons, check boxes and push buttons, wherein the user can employ various input devices (e.g., the mouse, the roller ball, the keypad, the keyboard, the pen and/or voice activation) in connection with the mechanism and utilities. For example, the user can provide a parameter or variable, or pointer thereto (e.g., a register location) via entering the information into an edit control box and/or highlighting an associated check box. Typically, a mechanism such as a push button is employed subsequent entering the information in order to initiate conveyance of the information. However, it is to be appreciated that the invention is not so limited. For example, merely highlighting the check box can initiate information conveyance.

The input and output mechanisms can be employed for various communication such as email, chat room, instant messaging, etc. In addition, URLs and/or hyperlinks can be utilized to locate and/or specify locations of information. Help files, debuggers, troubleshooting documentation and/or automatic event (e.g., error) loggers can be linked for manual and/or automatic invocation. Applications such as word processors, data analysis, scheduling utilities, project planners, etc. can be launched from drop-down menus, shortcuts and/or buttons.

In addition or alternatively, the Web interface 610 can include command-line functionality. For example, a command line can be employed to prompt for information via a text message and/or audio tone. The operator can than provide suitable information, such as alpha-numeric input corresponding to an option provided in the interface prompt or an answer to a question posed in the prompt. In another aspect of the present invention, a value, set of values or a stream of values can be presented to the user in the command line interface.

It is to be appreciated that the Web interface 610 can be generated in connection with an application programmer interface (API). As known, APIs facilitate building software applications via a set of routines, protocols, and tools, wherein developers and/or programmers can employ the API to construct customized applications consistent with the operating environment and a user(s) needs. In one aspect of the present invention, an SDK programming package, which typically includes one or more APIs and programming tools (including documentation), can be employed to develop the Web interface 610.

The Web interface 610 can couple a user and a network/device manger 620. The network/device manager 620 can provide a secure gateway to various disparate networks, including TCP/IP and non-TCP/IP-based networks, as described herein. For example, in one instance a user can request access to a network and/or device, in another instance the user can request that all available networks and/or devices be returned, and yet in another instance whenever a network and/or device is added or removed, the network/device manager 620 retrieves related information and displays updated network/device information to the user. Upon accessing a network and/or device, the user can monitor, configure, control and communicate with the network and/or device and/or obtain related information. For example, the user can monitor and control inputs, outputs, performance and settings and obtain manuals, web pages, logs, code, etc.

The intelligence component 630 can facilitate interaction with the disparate networks and/or devices. For example, the intelligence component 630 can make decisions and render inferences regarding returning available networks and/or devices that a user may desire to select while filtering less likely networks and/or devices, locating devices residing on a network unknown to the user, and configuring networks and/or devices, for example. Such intelligence can be based on statistics, probabilities, inferences and classifiers (e.g., explicitly and implicitly trained), including Bayesian learning, Bayesian classifiers and other statistical classifiers, such as decision tree learning methods, support vector machines, linear and non-linear regression and/or neural networks can be employed in accordance with an aspect of the present invention.

It is to be appreciated that the intelligence component 630 can be utilized to execute and/or facilitate searches and manage returned results. As noted previously, searches can be performed wherein a user can specify a particular node(s), a type(s) of node, a node characteristic(s), and a keyword(s) associated with a node(s), for example, and indicate that known search engines should additionally be invoked. The intelligence component 630 can employ such information along with the user's historical actions, training, environment characteristics, etc. to perform the search and present search results to the user. For example, results can be ranked and/or filtered based on criteria such as devices frequently accessed by the user, devices due for maintenance, devices associated with a logon account, devices in an unknown state, newly added devices that are to be configured, device in a fault condition, etc.

A user can configure the intelligence component 630 to perform actions with varying degrees of automation. For example, a user can specify that the intelligence component 630 prompt the user for additional information and/or approval prior to performing a task. In another example, the user can enable the intelligence component 630 to determine whether human interaction is needed. For example, the intelligence component 630 can generate a level of confidence for respective actions. The intelligence component 630 can then perform actions associated with a high level of confidence without human interaction and prompt the user for assistance for actions with a lower level of confidence.

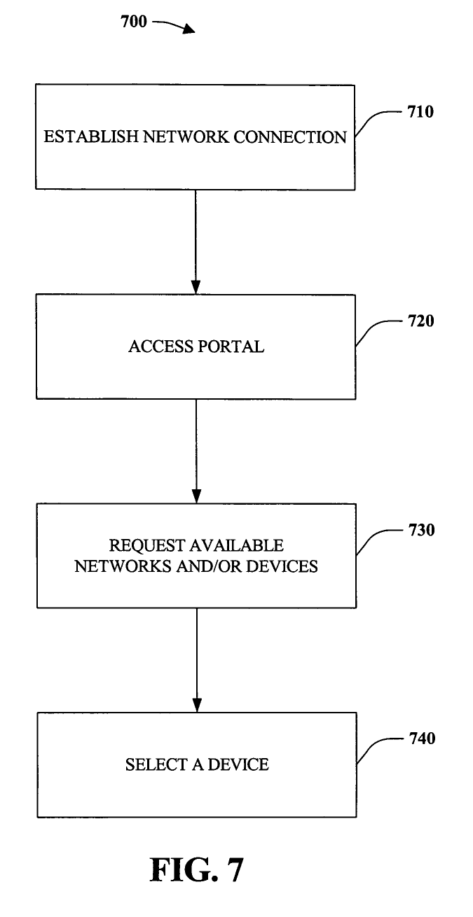

FIGS. 7-10 illustrate methodologies, in accordance with an aspect the present invention. While, for purposes of simplicity of explanation, the methodologies are shown and described as a series of acts, it is to be understood and appreciated that the present invention is not limited by the order of acts, as some acts can, in accordance with the present invention, occur in different orders and/or concurrently with other acts from that shown and described herein. For example, those skilled in the art will understand and appreciate that one or more of the methodologies could alternatively be represented as a series of interrelated states or events, such as in a state diagram. Moreover, not all illustrated acts may be required to implement the methodologies in accordance with the present invention.

Proceeding to FIG. 7, a methodology 700 that provides access to disparate networks and/or devices associated therewith is illustrated in accordance with an aspect of the present invention. At reference numeral 710, a user establishes a network connection. For example, the user can employ a computer to access a network (e.g., an intranet, an internet and the Internet) via a cable, a modem, broadband, satellite, T1, DSL, RF, and the like. Once connected, the user can invoke a network interface that can provide the user with a mechanism to communicate over the network. For example, the user can execute a network browser (e.g., Web browser). In another example, the user can launch an application wherein a network browser can be invoked from within the application (e.g., via an embedded URL).

At reference numeral 720, the user can access a portal to various disparate networks and/or devices via the network browser. As noted previously, the portal can be a Web page or a Web Proxy page with software that enables Web functionality with non-TCP/IP-based networks as well as TCP/IP networks. It is to be appreciated that the portal can be a secure interface, wherein only authorized users are provided with the ability to communicate with the disparate networks. For example, the portal can prompt for a security code and/or, identify the user by an account log-on or IP address.

At 730, the user can transmit a request for available TCP/IP and non-TCP/IP networks and/or devices. The request can be received through the portal by a component that can discover networks and/devices. For example, a Network Browse Engine can receive and service the request, wherein the Network Browse Engine searches for network and returns available TCP/IP and non-TCP/IP networks and/or associated devices.

At 740, the user can select a network and/or device to access. For example, the user can employ the network browser to monitor, control, configure and communicate with a device residing on a non-TCP/IP network (e.g., a ControlNet and DeviceNet). In addition, the user can retrieve and/or view information regarding the non-TCP/IP network and/or device. Such information can be obtained via manuals, web pages, files, etc. that can be downloaded and/or displayed within the network browser.

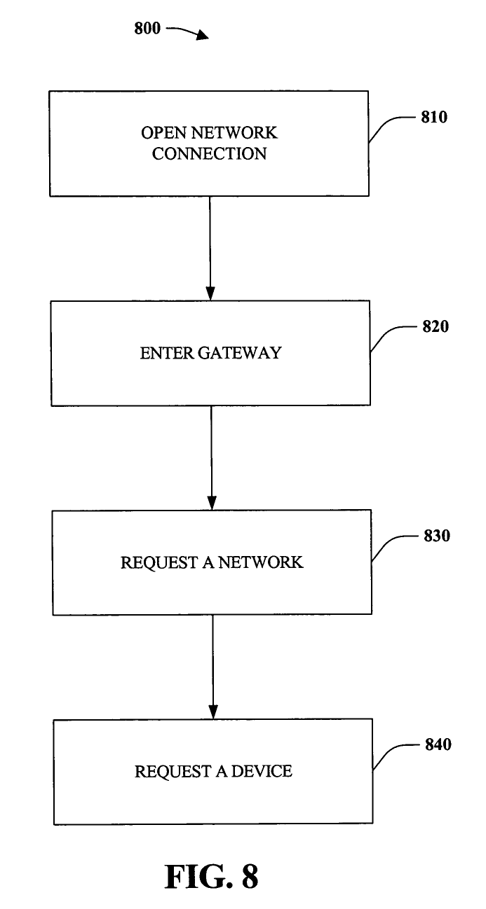

Next at FIG. 8, a methodology 800 that provides access to a user desired network and/or device is illustrated in accordance with an aspect of the present invention. At reference numeral 810, a user can open a network connection. For example, the user can instantiate a network connection via logging on to a computer with network access. For example, the user can be provided with an account, wherein the user enters a log on and/or password in order to gain access to the computer. Once logged on, the user can utilize the computer's network connection. In another example, the user, after gaining access to the computer, can open the network link via a cable, a modem, broadband, satellite, T1, DSL, RF, and the like.

At 820, the user can enter a gateway to a plurality of disparate networks. For example, the user can invoke an interface (e.g., Web browser) on the client computer that can communicate with the gateway. In another example, the user can launch an application such as a word processing application wherein the interface can be invoked from within the application (e.g., via an embedded URL). The gateway can be a Web page or a Web Proxy page with software that enables Web functionality with non-TCP/IP-based networks. In addition, the gateway can be configured to provide a secure interface. For example, the gateway can prevent undesired user from accessing any network and/or device via prompting for authorization, wherein only valid users can communicate with the disparate networks and/or devices.

At 830, the user can transmit a request for a particular network. For example, the user can launch a link, provide a URL, convey information indicative of the network, and/or include data that can be utilized to facilitate automatic determination of a suitable network. The request can be utilized to locate the network, search the network for active devices, and present the network and/or devices to the user. At 840, the user can transmit a request for a particular device on the network. Once access is established, the user can monitor, configure, control and communicate with the device. In addition, the user can retrieve and/or view information about the device via manuals, web pages, files, etc. that can be downloaded and/or displayed within a network browser.

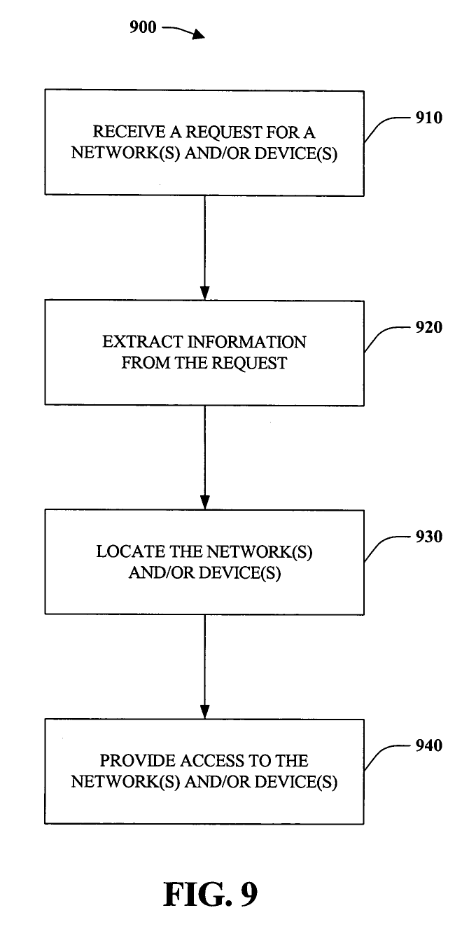

FIG. 9 illustrates a methodology that services requests for disparate networks and/or associated devices, in accordance with an aspect of the present invention. At 910, a request for one or more networks and/or devices is received via a Web Proxy page. The request can specify a particular network/device, a group of networks/devices or all available networks/devices. At 920, the information within the request is extracted and interpreted to facilitate servicing the request. The information can include data such as a request originator, a location, a time, a date, a sort technique, a filter algorithm, a unique identifiers, etc.

At 930, the requested network(s) and/or device(s) is located. In one instance, the information within the request is utilized to facilitate locating the desired network(s) and/or device(s). In another instance, intelligence (e.g., statistics, probabilities, classifiers, inferences, etc.) is further employed to facilitate locating the desired network(s) and/or device(s). At 940, information regarding the network(s) and/or device(s) can be returned to the user, wherein the user can select and access any network(s) and/or device(s). For example, the user can transmit a request to monitor, configure and/or control a device and/or retrieve and/or view information about the device, wherein such information can be obtained via manuals, web pages, files, etc. that can be downloaded and/or displayed within a network browser.

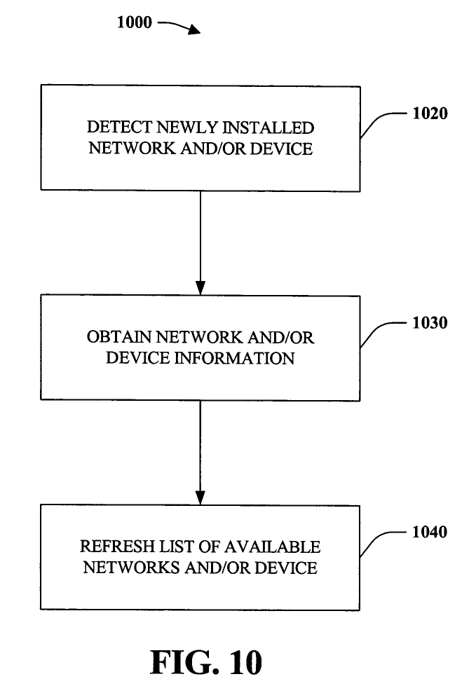

FIG. 10 illustrates a methodology that discovers disparate networks and/or associated devices, in accordance with an aspect of the present invention. At 1010, a newly installed network and/or device is detected. For example, a polling technique can be employed, wherein networks and/or devices are pinged periodically and/or a broadcast is transmitted to all entities. The response to the inquiry can provide information such as whether a new network and/or device has been installed and whether a current network and/or device has become inactive (e.g., removed, changed, and inoperable). In another example, a newly installed network and/or device, a master component and/or a user can transmit a notification indication such installation.

At reference numeral 1020, information regarding any newly installed network and/or device can be retrieved. In one aspect of the present invention, such information can be saved within a common storage area and deemed available to network and/or device requesters. In another aspect of the present invention, links to such information can be generated and provided to a user. In yet another aspect of the present invention, the information can be utilized to create a list of available networks and/or devices. It is to be appreciated that such information can be retrieved from memory (e.g., local and/or remote) associated with the device and/or provided by another means such as downloaded from CD, DVD, floppy, etc. For example, after a network and/or device is installed, associated information from at least the foregoing can be utilized to provide information such as software revision, model number, manuals, web pages, and the like. At 1030, the information can be utilized to apprise a user of available networks and/or devices.

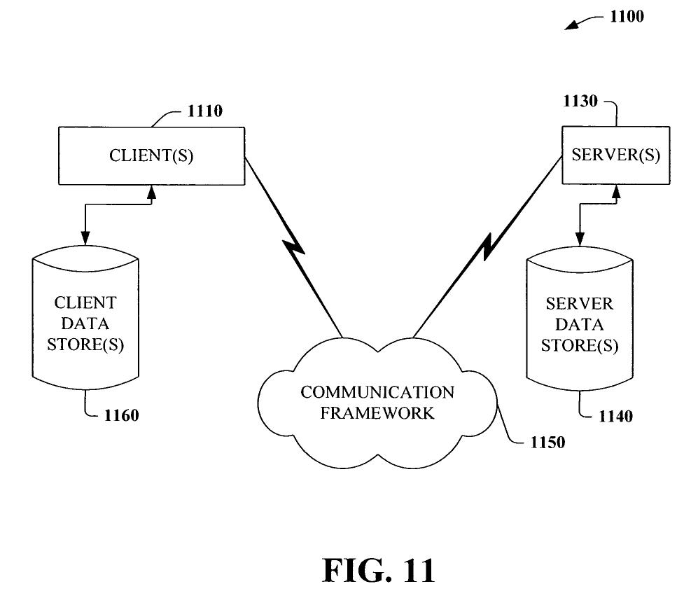

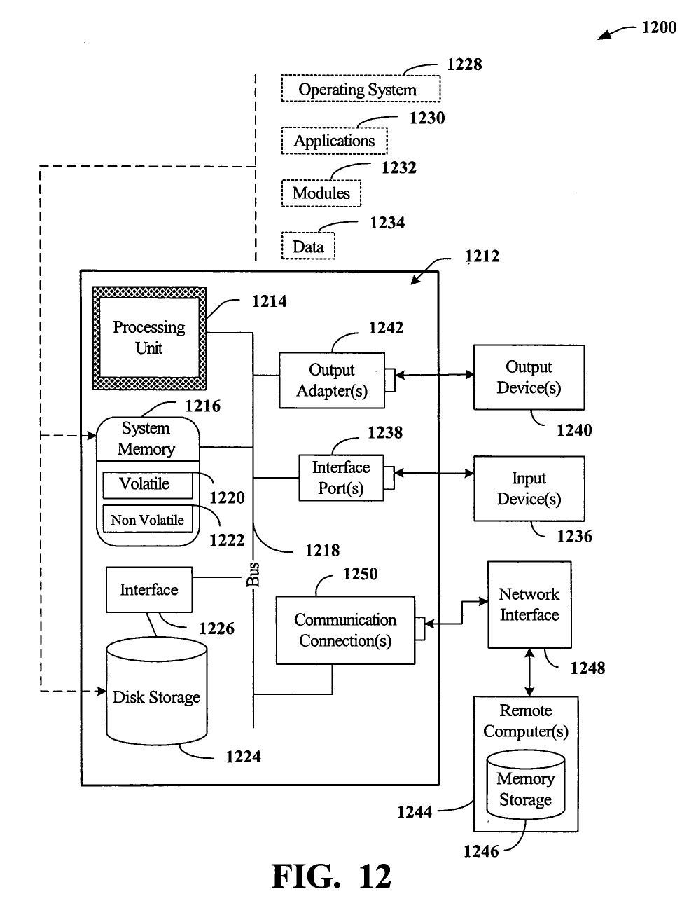

In order to provide a context for the various aspects of the invention, FIGS. 11 and 12 as well as the following discussion are intended to provide a brief, general description of a suitable computing environment in which the various aspects of the present invention can be implemented. While the invention has been described above in the general context of computer-executable instructions of a computer program that runs on a computer and/or computers, those skilled in the art will recognize that the invention also can be implemented in combination with other program modules. Generally, program modules include routines, programs, components, data structures, etc. that perform particular tasks and/or implement particular abstract data types.

Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and non-volatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A component that discovers devices on disparate networks within industrial control systems, comprising:
an interface component that couples at least one TCP/IP-based network with one or more non-TCP/IP-based networks; and,
a service component that searches the at least one TCP/IP-based network and the one or more non-TCP/IP-based networks for devices and returns information indicative of discovered devices.

2. The system of claim 1, the non-TCP/IP-based networks are employed in connection with one or more industrial protocols.

3. The system of claim 2, the industrial protocols comprise at least one of Ethernet/IP, DeviceNet and ControlNet.

4. The system of claim 1, the interface component and the service component reside within a microprocessor-based system or an EtherNet/IP-based module.

5. The system of claim 1, the interface component provides Web-based communication with the devices.

6. The system of claim 1, the service component periodically re-discovers networks and devices.

7. The system of claim 1, the service component detects when a network or device is added or removed and dynamically updates the returned information.

8. The system of claim 1, the interface component further provides a security mechanism that mitigates device access by unauthorized requesters.

9. The system of claim 8, the security mechanism is based on at least one of a policy, a password, a firewall, a code, an identity, a log-on, and an address.

10. The system of claim 1, the interface component is provided with at least one of the following to facilitate discovering devices: a particular device; a device type; a device characteristic; a requester identity; a keyword; and a link to a search engine.

11. The system of claim 10, the device characteristic indicates the search is directed to at least one of configured devices, added devices, removed devices and faulted devices.

12. The system of claim 1, the service component filters results prior to returning information.

13. A portal that provides Web communication with industrial devices residing on TCP/IP and non-TCP/IP networks, comprising:
a proxy component that facilitates access to the TCP/IP and non-TCP/IP networks; and,
an engine that discovers industrial devices residing on the TCP/IP and non-TCP/IP networks and provides information related to the industrial devices, the information can be utilized in connection with the proxy to communicate with the industrial devices.

14. The system of claim 13, the proxy component employs software that provides Web functionality for industrial devices on the non-TCP/IP networks.

15. The system of claim 13, the proxy component facilitates communication between industrial devices residing on similar and different networks.

16. The system of claim 13, the proxy component includes a Universal Serial Bus (USB) interface that facilitates receiving and conveying information with the industrial devices.

17. The system of claim 13, the non-TCP/IP-based networks employs at least one of a Control & Information Protocol (CIP) network and a Data Highway Plus (DH+) network.

18. The system of claim 13, the engine dynamically discovers newly added and removed networks and industrial devices and dynamically updates the related information.

19. The system of claim 13, the engine employs intelligence that facilitates locating and discovering industrial devices and returning related information, the intelligence employs at least one of a statistic, a probability, a classifier, and an inference.

20. The system of claim 13, the proxy component facilitates one or more of the following: controlling, configuring, monitoring, and communicating with the industrial devices.

21. The system of claim 13, the proxy component further comprises the ability to retrieve industrial device-related information from one or more of a manual, a web page, a log, a history and a file.

22. The system of claim 13 further comprises a configurable security component that verifies and validates authorization to one or more of the industrial devices.

23. A method for servicing a Web-based request for available devices residing on a non-TCP/IP-based network, comprising:
receiving the Web-based request;
searching for non-TCP/IP networks based at least in part on information within the Web-based request;
discovering devices residing on the non-TCP/IP networks; and
returning information indicative of the non-TCP/IP networks and the devices to a requester.

24. The method of claim 23 further comprises employing software that provides Web functionality for the devices on the non-TCP/IP networks.

25. The method of claim 23, the Web-based request comprises information related to at least one of the following: a request originator, a location, a time, a date, a sort technique, a filter, and a unique identifier.

26. The method of claim 23 further comprises dynamically updating the returned information when a network or device is added or removed.

27. A method to discover industrial devices residing on a non-TCP/IP-based network, comprising:
employing a proxy that couples TCP/IP and non-TCP/IP networks and provides Web-based functionality for the non-TCP/IP-based networks;
searching the one or more non-TCP/IP-based networks for industrial devices; and
returning information associated with the discovered industrial devices.

28. The method of claim 27 further comprises employing security to mitigate unauthorized access to the discovered devices.

29. The method of claim 27 further comprises employing intelligence to facilitate discovering devices and returning device-related information.

30. A system that facilitates Web access to industrial devices residing on disparate networks, comprising:
means for interacting with TCP/IP and non-TCP/IP networks;
means for discovering industrial devices associated with the TCP/IP and non-TCP/IP-based networks;
means for returning information indicative of the discovered devices; and
means for accessing the discovered devices.
